(19) United States
(12) Patent Application Publication
(10) Pub. No.: US 2012/0119397 A1
(43) Pub. Date: May 17, 2012

(54) METHOD FOR PRODUCING DISPERSION LIQUID CONTAINING PEST CONTROLLING COMPOSITION AND METHOD FOR PRODUCING MICROCAPSULE

(75) Inventors: Masao KOJIO, Osaka-shi (JP); Seiji IUCHI, Chuo-ku (JP)

(73) Assignee: SUMITOMO CHEMICAL COMPANY, LIMITED, Tokyo (JP)

(21) Appl. No.: 13/290,669

(22) Filed: Nov. 7, 2011

(30) Foreign Application Priority Data
Nov. 11, 2010 (JP) 2010-252700

(51) Int. Cl. B01J 13/04; A01P 7/04; A01N 43/78

(52) U.S. Cl. 264/4.1; 514/365

(57) ABSTRACT

Provided is a method for continuously producing a dispersion liquid containing a pest controlling composition. This method includes steps of: dispersing a suspension and a dispersion medium in a first dispersion tank by stirring the suspension and the dispersion medium in the first dispersion tank while continuously supplying the suspension and the dispersion medium into the first dispersion tank, the suspension being formed by suspending a solid pest controlling composition in a water-immiscible organic solvent and the dispersion medium being formed from water or a water solvent containing an alcohol; and stirring a first dispersion liquid in a second dispersion tank while continuously supplying into the second dispersion tank the first dispersion liquid discharged continuously from the first dispersion tank, wherein the stirring of the first dispersion liquid is continued until a dispersion state of the first dispersion liquid becomes stable.

This Nonprovisional application claims priority under 35 U.S.C. §119(a) on Patent Application No. 2010-252700 filed in Japan on Nov. 11, 2010, the entire contents of which are hereby incorporated by reference.

### TECHNICAL FIELD

The present invention relates to a method for producing a dispersion liquid containing a pest controlling composition and a method for producing a microcapsule. (In this Description, the term “pest” means a noxious organism or noxious organisms.)

### BACKGROUND ART

A dispersion liquid containing a pest controlling composition is used as, for example, an intermediate for producing a microcapsule which is useful as a controlled release formulation of a pest controlling composition (e.g., see Patent Literature 1 and Patent Literature 2).

There has been known a conventional method for producing such a dispersion liquid (e.g., see Patent Literature 1 and Patent Literature 2). In this method, a dispersion liquid is produced by suspending a pest controlling composition in a water immiscible solvent so as to obtain a suspension, adding deionized water in the suspension, and dispersing a resultant mixture in a batch dispersing device. However, a method for producing the dispersion liquid continuously has never been known.

### CITATION LIST

### Patent Literatures

Patent Literature 1
Japanese Patent Application Publication, TokukaiHei, No. 08-99805 A

Patent Literature 2
Japanese Patent Application Publication, Tokukai, No. 2007-186497 A

### SUMMARY OF INVENTION

### Technical Problem

The conventional method employs a batch dispersing device, so that the amount of dispersion liquid that can be produced at one time is limited. In view of the circumstances, there has been a demand for continuously producing a dispersion liquid containing a pest controlling composition, in which method the amount of dispersion liquid that can be produced at one time is not limited.

### Solution to Problem

The present invention provides a method for producing a dispersion liquid containing a pest controlling composition includes steps of: dispersing a suspension and a dispersion medium in a first dispersion tank by stirring the suspension and the dispersion medium in the first dispersion tank while continuously supplying the suspension and the dispersion medium into the first dispersion tank, the suspension being formed by suspending a solid pest controlling composition in a water-immiscible organic solvent and the dispersion medium being formed from water or a water solvent containing an alcohol; and stirring a first dispersion liquid in a second dispersion tank while continuously supplying into the second dispersion tank the first dispersion liquid discharged continuously from the first dispersion tank, wherein the stirring of the first dispersion liquid is continued until a dispersion state of the first dispersion liquid becomes stable.

Further, the method for producing a dispersion liquid containing a pest controlling composition further includes a step of stirring a second dispersion liquid in a third dispersion tank while continuously supplying into the third dispersion tank the second dispersion liquid continuously discharged from the second dispersion tank, wherein the stirring of the second dispersion liquid is continued until a dispersion state of the second dispersion liquid becomes stable.

The stirring is preferably carried out within a range from 500 to 3000 of Reynolds number.

A viscosity of the suspension preferably falls within a range of 100 mPa·s or more and 10000 mPa·s or less. A supply amount of the dispersion medium is preferably larger than a supply amount of the suspension by 0.8 times to 2 times.

The suspension may contain a monomer having a functional group that is thermally polymerizable.

Further, the present invention provides a method for producing a microcapsule, including a step of: preparing a dispersion liquid by the method for producing a dispersion liquid containing a pest controlling composition, in which dispersion liquid the suspension containing a monomer having a functional group that is thermally polymerizable is dispersed in the dispersion medium; and heating the dispersion liquid so as to polymerize the monomer contained in the dispersion liquid, so as to form a film on a surface of a liquid droplet of the suspension dispersed into a dispersion medium.

### Advantageous Effects of Invention

A method according to the present invention for producing a dispersion liquid can continuously produce a dispersion liquid containing a pest controlling composition.

### BRIEF DESCRIPTION OF DRAWINGS

FIG. 1

FIG. 1 is a graph showing a relationship between the liquid droplet circulation number and a liquid droplet diameter, for different rpm (revolutions per minute) of a mixing impeller.

FIG. 2

FIG. 2 is a graph showing a relationship between rpm of a mixing impeller and a liquid droplet diameter.

FIG. 3

FIG. 3 is a graph showing a relationship between Reynolds number Re and a discharge flow coefficient Nq.

FIG. 4

FIGS. 4(a) is a view showing an example of a liquid droplet size distribution obtained when one dispersion tank is used, and FIG. 4(b) is a view showing an example of liquid droplet size distribution obtained when two or more dispersion tanks are connected to one another in series.

FIG. 5

FIG. 5 is a graph showing a relationship between the liquid droplet circulation number and a liquid droplet diameter in a case where five dispersion tanks are connected to one another in series.

FIG. 6

FIG. 6 is a process diagram illustrating an example of a method according to the present invention for producing a dispersion liquid containing a pest controlling composition and a method according to the present invention for producing a microcapsule.

### DESCRIPTION OF EMBODIMENTS

Prior to description of an embodiment according to the present invention, processes that lead to the present invention will be described.

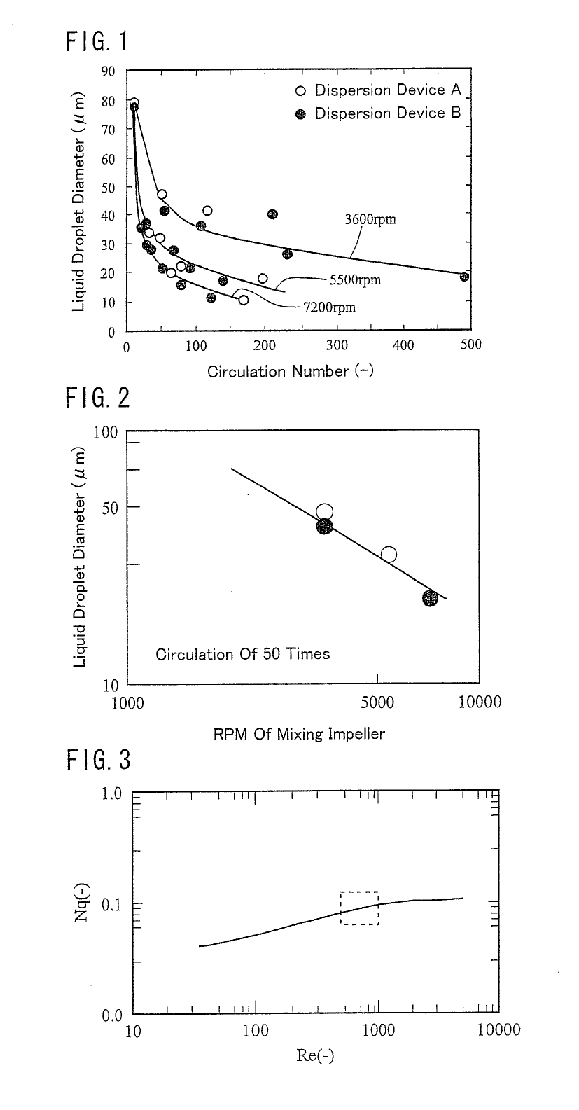

A relationship between a liquid droplet diameter and a liquid droplet circulation number (how many times liquid droplets are circulated) or the number of circulations of the liquid droplets was examined by changing a supply amount of a suspension and water (dispersion medium), which were supplied to the dispersion tanks, with use of two dispersion devices (dispersion tanks) having respective different capacities as shown in the Table 1 described later. The result is shown in FIG. 1. Meanwhile, a relationship between rpm of a mixing impeller and the liquid droplet diameter was examined by changing the rpm of the mixing impeller. The result is shown in FIG. 2.

TABLE 1

| | Dispersing device A | Dispersing device B |
|---|---|---|
| Capacity | 0.4 L | 1.4 L |
| Diameter of | 2.9 cm | 4.8 cm |
| mixing impeller | | |
| rpm | 3600 rpm to 7200 rpm | 3600 rpm to 7200 rpm |
| Supply amount | 3 L/h to 35 L/h | 4 L/h to 400 L/h |

Note that the liquid droplet circulation number P is calculated from a theoretical formula (1).

P=Q/F (1)

(where Q represents a discharge flow (m³/s), and F represents a supply flow rate (m³/s).)

Q=Nq×N×D³/1000

(where Nq represents a discharge flow coefficient, N represents rpm (S⁻¹), and D represents a mixing impeller diameter (m).)

The discharge flow coefficient Nq is varied in accordance with a state of flowing the dispersion liquid, i.e., the Reynolds number Re, so that the discharge flow coefficient Nq may be appropriately determined from, for example, a relationship shown in FIG. 3.

FIG. 1 is a graph showing a relationship between the liquid droplet circulation number and a liquid droplet diameter, for different rpm (revolutions per minute) of a mixing impeller. In FIG. 1, the vertical axis denotes a liquid droplet diameter, and the horizontal axis denotes the liquid droplet circulation number. As is apparent from FIG. 1, a liquid droplet diameter is reduced as the liquid droplet circulation number is increased. In addition, in the case where mixing impellers of respective dispersion tanks have the same rpm, liquid droplet diameters in two dispersion tanks are varied similarly to be associated with the same curves, irrespective of capacities of the dispersion tanks. Further, in the case where the dispersion tanks have the same liquid droplet circulation number, a rapider rpm of a mixing impeller causes the liquid droplet diameter to be small.

FIG. 2 is a graph showing a change in a liquid droplet diameter against rpm of a mixing impeller after a liquid droplet is circulated 50 times. In FIG. 2, the vertical axis denotes a liquid droplet diameter, and the horizontal axis denotes the liquid droplet circulation number. As is apparent from FIG. 2, the liquid droplet diameter is reduced as the rpm of mixing impeller is increased.

The aforementioned results of the basic experiment shows that, in order to control liquid droplets in the dispersion liquid to have a predetermined diameter, a supply amount of a suspension and water supplied to the dispersion tank may be determined so that: the rpm of the mixing impeller causes the dispersion liquid to keep a laminar flow and a liquid droplet is circulated a predetermined times.

In order to increase a production amount of dispersion liquid, it is necessary to increase a supply amount of the suspension and water. Meanwhile, in order to obtain a predetermined circulation number in a predetermined time period, it is necessary to increase the rpm of the mixing impeller. However, when the rpm of the mixing impeller is increased, the dispersion liquid cannot keep the laminar flow.

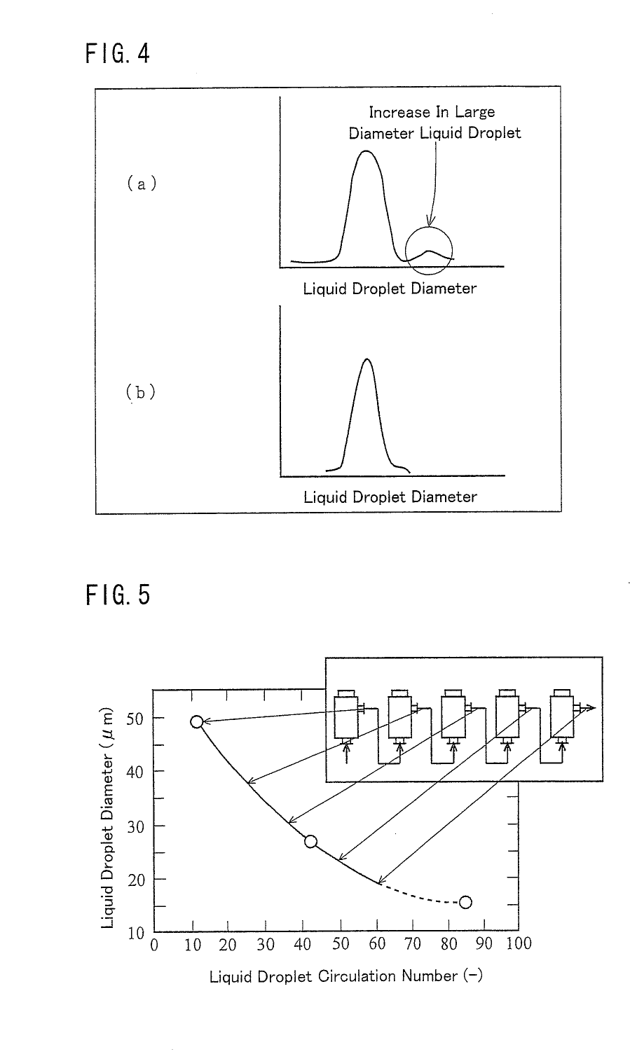

In view of the circumstances, a method according to the present invention for producing a dispersion liquid or a microcapsule is arranged such that two or more dispersion tanks are connected to one another in series in a state in which the rpm of the mixing impeller is set to such an extent that the dispersion liquid can keep a laminar flow, whereby a liquid droplet can be circulated predetermined times. This method succeeds in increasing in the production amount of the dispersion liquid while obtaining a predetermined liquid droplet diameter. FIG. 4(a) shows a liquid droplet size distribution obtained when the liquid droplet was circulated predetermined times in one dispersion tank. FIG. 4(b) shows a liquid droplet size distribution obtained when five dispersion tanks were connected to one another in series and the liquid droplet circulation number was reduced to one-fifths of the case of the one dispersion tank. As is apparent from these drawings, in the case where liquid droplets are circulated predetermined times in the one dispersion tank, some liquid droplets remain to have a large diameter. Further, the five dispersion tanks connected to one another in series can obtain liquid droplets having more uniform size than one dispersion in which the liquid droplets are circulated predetermined times.

In a case where a plurality of dispersion tanks are connected to one another in series, the liquid droplet circulation number per dispersion tank is calculated from a production amount of dispersion liquid and the rpm of a mixing impeller. Meanwhile, in order to obtain a predetermined liquid droplet diameter, the liquid droplet circulation number of all dispersion tanks is calculated from the theoretical formula (1). Then, the liquid droplet circulation number of all dispersion tanks, which is calculated from the theoretical formula (1), is divided by the liquid droplet circulation number per dispersion tank. In this way, the necessary number of dispersion tanks is calculated and then dispersion tanks thus calculated are connected to one another in series.

Assuming that, for example, a dispersion liquid having a liquid droplet diameter of about 20 μm can be obtained in a case where a supply amount of a suspension and water is 75 kg/h and liquid droplets of the suspension and water are circulated 60 times in one dispersion tank. In this case, if the supply amount of the suspension and water is simply increased to 375 kg/h (which is five times as much as the case of 75 kg/h), liquid droplet circulation number is reduced to 12 times and each liquid droplet diameter becomes much larger than 20 μm. In order to increase a production amount of a dispersion liquid to 375 kg/h (which is five times as much as the case of 75 kg/h) while obtaining a liquid droplet having a diameter of 20 μm in the dispersion liquid, it is necessary to connect five dispersion tanks to one another in series (liquid droplet circulation number of all dispersion tanks: 60 times, liquid droplet circulation number per dispersion tank: 12 times).

FIG. 5 shows a relationship between an integrating liquid droplet circulation number and a liquid droplet diameter, in the case where 375 kg/h of a suspension and water is supplied and liquid droplets were circulated 12 times in a state in which five dispersion tanks are connected to one another in series. As is apparent from FIG. 5, a liquid droplet diameter in a first dispersion tank became about 48 μm, the liquid droplet diameter in a second dispersion tank became about 37 μm, and the diameter in a third dispersion tank became about 30 μm. The liquid droplets in the dispersion liquid were circulated 60 times in total, and a diameter of each liquid droplet in the dispersion liquid discharged from the fifth dispersion tank finally became about 20 μm.

The pest controlling composition for use in the present invention is preferably a solid having a melting point of 50° C. or more. Specifically, examples of the pest controlling composition encompass (E)-1-(2-chloro-1,3-thiazole-5-ylmethyl)-3-methyl-2-nitroguanidine (hereinafter, may be referred to also as “clothianidin”), metoxadiazone{5-methoxy-3-(2-methoxyphenyl)-1,3,4-oxadiazole-2(3H)-on}, diniconazole{(E)-1-(2,4-dichlorophenyl)-4,4-dimethyl-2-(1H-1,2,4-triazole-1-yl)pent-1-en-3-ol}, procymidone{N-(3,5-dichlorophenyl)-1,2-dimethylcyclopropane-1,2-dicarboximide}, oxolinic acid{5-ethyl-5,8-dihydro-8-oxiso[4,5-g]quinolin-7-carboxylic acid}, bromobutide{2-bromo-N-(α,α-dimethylbenzyl)-3,3-dimethylbutanamide}, flumiclorac-pentyl{pentyl 2-chloro-4-fluoro-5-(3,4,5,6-tetrahydrophthalimide)phenoxyacetate}, uniconazole{(E)-1-(4-chlorophenyl)-4,4-dimethyl-2-(1H-1,2,4-triazole-1-yl)pent-1-en-3-ol}, tetramethrin{3,4,5,6-tetrahydrophthalimide methyl chrysanthemate}, resmethrin {5-benzyl-3-furylmethyl chrysanthemate}, dioxabenzofos{2-methoxy-4H-benzo-1,3,2-dioxaphosphorin-2-sulfide}, xylylcarb{3,4-xylyl methyl carbamate}, tolclofos methyl{O-(2,6-dichloro-4-methylphenyl) O,O-dimethyl phosphorothioate}, dimethoate{O,O-dimethyl S-methylcarbamoylmethyl phosphorodithioate}, diethofencarb{isopropyl 3,4-diethoxycarbanilate}, and the like.

The water immiscible organic solvent for use in the present invention is appropriately selected in accordance with a kind of the pest controlling composition so as to select a water immiscible organic solvent that can disperse the pest controlling composition but not dissolving the pest controlling composition too much. Examples of the water immiscible organic solvent encompass: aliphatic hydrocarbons such as trimethylpentane; aromatic hydrocarbons such as phenylxylyl ethane; alcohols such as hexanol and octanol; ketones such as diisobutyl ketone; esters such as 2-ethylhexylacetate, dibutyl maleate, and diisodecyl adipate; ethers such as 2-ethylhexyl ether; mineral oil such as machine oil, vegetable oil such as cottonseed oil; and mixtures thereof. A pest controlling composition preferably has solubility of 5% by weight or less in the water immiscible organic solvent.

A dispersion device for use in the present invention is not particularly limited, and conventionally-known dispersion devices can be used. However, a stirring type dispersion device is preferable. A commercial product such as “T.K. HOMOMIC LINE FLOW” (manufactured by PRIMIX Corporation) can be preferably used.

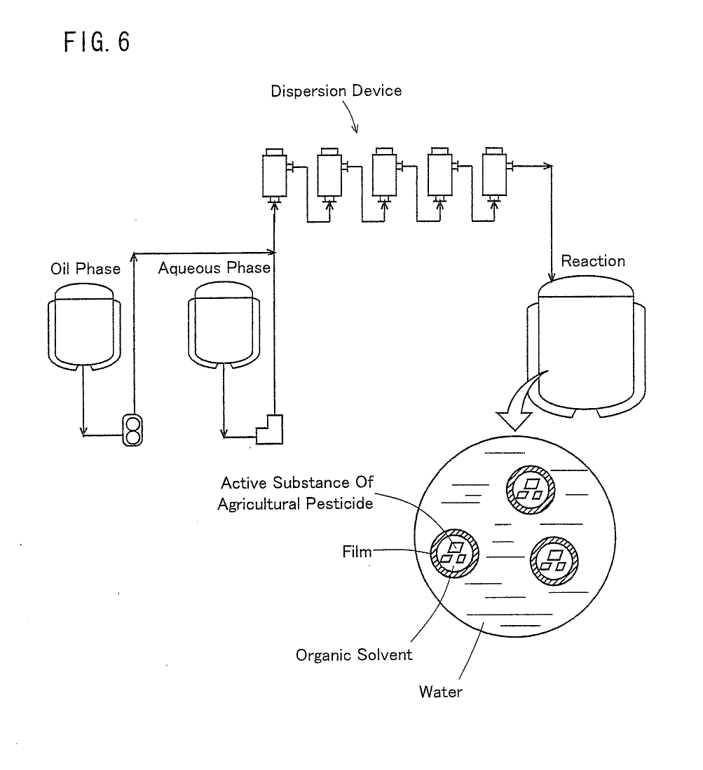

FIG. 6 shows a general process diagram illustrating a method according to the present invention for producing a dispersion liquid containing a pest controlling composition and a method according to the present invention for producing a microcapsule. First, a suspension is prepared as an oil phase. Specifically, the suspension is obtained by fine-grinding a pest controlling composition in a water immiscible organic solvent, or by dispersing into a water immiscible organic solvent a pest controlling composition fine-ground in advance. A wet grinding mill is used to obtain the suspension by fine-grinding the pest controlling composition in the water immiscible organic solvent, such as Attritor (manufactured by Mitsui Miike Kakoki), DYNO-MILL (manufactured by Shinmaru Enterprises Corporation), Colloid Mill (manufactured by Tokushu Kika Kogyo Co., Ltd.), or Pearl Mill (manufactured by Ashizawa Iron Works Ltd.). Meanwhile, a dry grinding mill is used to obtain the suspension by dispersing into the water immiscible organic solvent the pest controlling composition fine-ground in advance, such as Atomizer (manufactured by Fuji Paudal Co., Ltd.), or Jet-O-Mizer (manufactured by Seishin Enterprise Co., Ltd.). The prepared suspension preferably has a viscosity within a range from 100 mPa·s to 10000 mPa·s.

In order to obtain the suspension liquid as described above, the following auxiliary may be added: an anionic surfactant such as fatty acid soap, ether carboxylate, salt of condensate of higher fatty acid and amino acid, higher alkyl sulfonate, α-olefinsulfonate, sulfonate of higher fatty acid ester, dialkylsulfosuccinates, sulfonate of higher fatty acid amide, alkylarylsulfonate, higher alcohol sulfate ester salt, alkyl ethereal sulfate ester salt, alkyl aryl ethereal sulfate ester salt, sulfate ester salt of higher fatty acid ester, sulfate ester salt of higher fatty acid alkylol amide, sulfonated oil, or phosphate; a nonionic surfactant such as polyoxyethylene alkyl ether, polyoxyethylene alkyl aryl ether, formaldehyde condensate of polyoxyethylene alkyl phenol, polyoxyethylene fatty acid ester, polyoxyethylated oil, polyoxyethylated wax, polyhydric alcohol ester, or polyoxyethylene polyoxypropylene block copolymer; a thickener such as, silica or organic modifier montmorillonites.

Meanwhile, a dispersion medium as an aqueous phase, which is formed from water or a water solvent containing alcohol, is preferably added with a dispersing agent in advance. Examples of the dispersing agents encompass: a water-soluble polymer such as gelatin, gum arabic, casein, dextrin, pectin, sodium alginate, methyl cellulose, ethyl cellulose, carboxymethyl-cellulose sodium, hydroxyethyl cellulose, hydroxypropyl cellulose, sodium polyacrylate, polyvinyl alcohol, polyvinyl pyrrolidone, or carboxyvinyl polymer; an anionic surfactant such as fatty acid soap, ether carboxylate, ether carboxylic acid, salt of condensate of higher fatty acid and amino acid, higher alkyl sulfonate, α-olefinsulfonate, sulfonate of higher fatty acid ester, dialkylsulfosuccinates, sulfonate of higher fatty amid, alkylarylsulfonic acid, higher alcohol sulfate ester salt, alkyl ethereal sulfate ester salt, alkyl aryl ethereal sulfate ester salt, sulfate ester salt of higher fatty acid ester, sulfate ester salt of higher fatty acid alkylol amide, sulfonated oil, or phosphate; a cationic surfactant such as alkyl amine salts, or amine salt of polyamine or amino alcohol fatty acid derivative, alkyl quaternary ammonium salt, cyclic quaternary ammonium salt, quaternary ammonium salt containing hydroxyl group, or quaternary ammonium salt containing ether linkage; an amphoteric surfactant of carboxylic type, sulfate type, sulfonate type, phosphate ester type, or other types; a nonionic surfactant such as polyoxyethylene alkyl ether, polyoxyethylene alkyl aryl ether, formaldehyde condensate of polyoxyethylene alkyl phenol, polyoxyethylene fatty acid ester, polyoxyethylated oil, polyhydric alcohol ester, or polyoxyethylene polyoxypropylene block copolymer; and the like.

Note that, in microencapsulating a liquid droplet finally by forming a film on a surface of the liquid droplet, a monomer having a functional group that is thermally polymerizable is added into the suspension in advance, such as polyvalent isocyanate (e.g., hexamethylene diisocyanate, trimethyl hexamethylene diisocyanate, isophorone diisocyanate, phenylene diisocyanate, toluene diisocyanate, xylylene diisocyanate, naphthalene diisocyanate, and polymethylene polyphenyl diisocyanate), polycarboxylic acid chloride (e.g., sebacic acid dichloride, adipic acid dichloride, azelaic acid dichloride, terephthalic acid dichloride, and trimesic acid dichloride), polysulfonyl chloride (e.g., benzene sulfonyl dichloride). Further, as necessary, a polymerization initiator and the following water-soluble film forming material are added into water into which suspension liquid droplets are dispersed, such as polyalcohol (e.g., ethylene glycol, butanediol, and hexanediol) or polyamine (e.g., ethylenediamine, hexamethylenediamine, phenylenediamine, diethylenetriamine, triethylenetetramine, and piperazine). Film thickness of the microcapsule can be adjusted by changing the addition amount of the monomer.

Next, the suspension and the dispersion medium formed from the water or the water solvent containing alcohol are continuously supplied to dispersion means. The dispersion means is formed by connecting two or more dispersion tanks (five dispersion tanks in FIG. 6) to one another. A supply ratio of the suspension to the dispersion medium is not particularly limited, however, a supply amount of the dispersion medium is preferably larger than a supply amount of the suspension by 0.8 times to 2 times. Adjusting the supply ratio to 0.8 times to 2 times can form uniform size liquid droplets.

Then, the suspension is dispersed into the dispersion medium by the dispersion means in which two or more dispersion tanks are connected to one another as described above, so that uniform size liquid droplets can be continuously obtained.

A dispersion liquid formed in this way (i.e., a dispersion liquid into which liquid droplets containing a pest controlling composition are dispersed) can be used as such to be an agricultural pesticide. However, the liquid droplets in the dispersion liquid are generally microencapsulated by forming a film on a surface of the liquid droplet. In a case of microencapsulating the liquid droplets, a monomer having a functional group is thermally polymerizable is added into the suspension in advance, meanwhile, a polymerization initiator is added into the water or the water solvent containing alcohol in advance as necessary, as described above. The dispersion liquid is heated to, for example, 40° C. to 80° C. and then is kept at a range of temperature for about 0.5 hours to 48 hours, so that polymerization reaction proceeds and each liquid droplet is covered with a film.

### EXAMPLES

The present invention will be described in more detail with examples, however, it should be noted that the present invention is not limited to these examples.

### Example 1

Firstly, 150 parts by weight of Clothianidin and 414 parts by weight of O-methyl acetyl ricinoleate (RICSIZER C-101; manufactured by Itoh Oil Chemicals Co., Ltd.; content of 95.5%) were mixed together. Then, a mixture thus obtained was stirred in a reaction tank in which a high-speed shear vane was provided, and the clothianidin contained in the mixture was ground by a PUC colloid mill type 160 (manufactured by NIPPON BALL VALVE CO., LTD.) to be particles of a clothianidin having a volume median diameter of 15 μm.

The ground product was added into DYNO-MILL (manufactured by Shinmaru Enterprises Corporation, vessel size of 16.5 L, 20.2 kg of spherical glass of an average particle size of 0.5 mm was filled in, rotational speed of an impeller: peripheral speed of 12 m/sec) at a rate of 220 L/hr, so that particles of the clothianidin were further ground (hereinafter, the product thus further ground is referred to as “ground product A”). The particles of the clothianidin in the ground product A had a volume median diameter of 2.3 μm. Thereafter, a slurry remained in a pipe was collected by washing the pipe with 50 parts by weight of O-methyl acetyl ricinoleate.

Then, 132 parts by weight of Polyisocyanate (Sumidur L-75, manufactured by Sumika Bayer Urethane Co., Ltd.) was added into the 614 parts by weight of ground product A of at a temperature of 20° C. A mixture thus obtained was stirred at 20° C. for one hour. The mixture thus obtained is referred to as “mixture B”.

Then, 229 parts by weight of Ethylene glycol (manufactured by NIPPON SHOKUBAI CO., LTD.) and 232 parts by weight of Gum Arabic (Arabic Cole SS manufactured by SAN-EI YAKUHIN BOEKI CO., LTD.) were added into 2166 parts by weight of water (deionized water), so that an aqueous phase of the water was prepared (a mixture thus obtained is referred to as “mixture C”). Thereafter, the mixture B and the mixture C were adjusted to 25° C. Then, the mixture B and the mixture C were supplied into a pipe at a rate of 105 L/hr and at a rate of 115 L/hr, respectively, and mixed in the pipe thereby obtaining a mixture which is referred to as “mixture D” hereinafter.

The mixture D was supplied to and stirred in dispersion means in which the three dispersion devices (T.K. HOMOMIC LINE FLOW LF-100 manufactured by PRIMIX Corporation, 8000 rpm) were connected to one another in series so that liquid droplets of the mixture D were dispersed into the water. Note that the supply of the mixture C was continued at the aforementioned rate until the mixture B was used up, thereby remaining part of the mixture C unused. Liquid droplets of a dispersion liquid obtained in this way had a volume median diameter of 21 μm.

The dispersion liquid was stirred at 60° C. for 24 hours, thereby obtaining an aqueous suspension composition including microcapsules of liquid droplets containing clothianidin. The microcapsules had a volume median diameter of 23 μm. A standard deviation σ of liquid droplet size distribution was 0.24.

### Reference Example 1

Firstly, 10.6 parts by weight of Clothianidin and 32.5 parts by weight of O-methyl acetyl ricinoleate (RICSIZER C-101; manufactured by Itoh Oil Chemicals Co., Ltd.; content of 95.5%) were mixed together. Then, a mixture thus obtained was stirred in a reaction tank in which a high-speed shear vane was provided, and the clothianidin contained in the mixture was ground by a PUC colloid mill type 60 (manufactured by NIPPON BALL VALVE CO., LTD.) to be particles of a clothianidin having a volume median diameter of 0.04 mm.

The ground product was added into DYNO-MILL (manufactured by Shinmaru Enterprises Corporation, vessel size of 5.0 L, 6.12 kg spherical glass of an average particle size of 0.5 mm was filled in, rotational speed of an impeller: peripheral speed of 12 m/sec) at a rate of 75 L/hr, so that particles of the clothianidin were further ground (hereinafter, the product thus further ground is referred to as “ground product E”). The particles of clothianidin in the ground product E had a volume median diameter of 2.5 p.m.

Then, 9.3 parts by weight of Polyisocyanate (Sumidur L-75, manufactured by Sumika Bayer Urethane Co., Ltd.) was added into 43.0 parts by weight of the ground product E of at a temperature of 20° C. A mixture thus obtained was stirred at 20° C. for one hour. The mixture thus obtained is referred to as “mixture F”.

Then, 4.26 parts by weight of Ethylene glycol and 4.20 parts by weight of Gum Arabic (Arabic Cole SS manufactured by SAN-EI YAKUHIN BOEKI CO., LTD.) were added into 38.8 parts by weight of water (deionized water), so that an aqueous phase of the water was prepared (a mixture thus obtained is referred to as “mixture G”). Thereafter, the mixture F and the mixture G were adjusted to 25° C. Then, the mixture F and the mixture G were supplied into a pipe at a rate of 35.6 L/hr and at a rate of 39.3 L/hr, respectively, and mixed in the pipe thereby obtaining a mixture which is referred to as “mixture H” hereinafter.

The mixture H was supplied to and stirred in T.K. HOMOMIC LINE FLOW LF-100 manufactured by PRIMIX Corporation at 7200 rpm so that liquid droplets of the mixture H were dispersed into water. Liquid droplets of a dispersion liquid obtained in this way had a volume median diameter of 21 μm.

The dispersion liquid was stirred at 60° C. for 24 hours, thereby obtaining an aqueous suspension composition including microcapsules of liquid droplets containing clothianidin. The microcapsules had a volume median diameter of 22 μm. A standard deviation a of liquid droplet size distribution was 0.37.

### INDUSTRIAL APPLICABILITY

A method for producing a dispersion liquid containing a pest controlling composition and a method for producing a microcapsule according to the present invention are useful because these methods can continuously produces a dispersion liquid containing a pest controlling composition.

1. A method for producing a dispersion liquid containing a pest controlling composition, comprising steps of:
dispersing a suspension and a dispersion medium in a first dispersion tank by stirring the suspension and the dispersion medium in the first dispersion tank while continuously supplying the suspension and the dispersion medium into the first dispersion tank, the suspension being formed by suspending a solid pest controlling composition in a water-immiscible organic solvent and the dispersion medium being formed from water or a water solvent containing an alcohol; and
stirring a first dispersion liquid in a second dispersion tank while continuously supplying into the second dispersion tank the first dispersion liquid discharged continuously from the first dispersion tank, wherein the stirring of the first dispersion liquid is continued until a dispersion state of the first dispersion liquid becomes stable.

2. The method according to claim 1, further comprising a step of stirring a second dispersion liquid in a third dispersion tank while continuously supplying into the third dispersion tank the second dispersion liquid continuously discharged from the second dispersion tank, wherein the stirring of the second dispersion liquid is continued until a dispersion state of the second dispersion liquid becomes stable.

3. The method according to claim 1, wherein the stirring is carried out within a range from 500 to 3000 of Reynolds number.

4. The method according to claim 1, wherein a viscosity of the suspension falls within a range of 100 mPa·s or more and 10000 mPa·s or less

5. The method according to claim 1, wherein a supply amount of the dispersion medium is larger than a supply amount of the suspension by 0.8 times or more to 2 times or less.

6. The method according to claim 1, wherein the suspension contains a monomer having a functional group that is thermally polymerizable.

7. A method for producing a microcapsule, comprising a step of:
preparing a dispersion liquid by a method according to claim 6 for producing a dispersion liquid containing a pest controlling composition; and
heating the dispersion liquid so as to polymerize the monomer contained in the dispersion liquid, so as to form a film on a surface of a liquid droplet of the suspension dispersed into a dispersion medium.
